(19) United States
(12) Patent Application Publication
(10) Pub. No.: US 2013/0065414 A1
(43) Pub. Date: Mar. 14, 2013

(54) ELECTRICAL CONNECTOR

(71) Applicants: Wang-I YU, JHONGHE (CN); Kuo-Cheng LIU, Taicang (CN)

(72) Inventors: Wang-I YU, JHONGHE (CN); Kuo-Cheng LIU, Taicang (CN)

(73) Assignee: ALLTOP ELECTRONICS (SUZHOU) CO., LTD, Taicang City (CN)

(21) Appl. No.: 13/281,937

(22) Filed: Oct. 26, 2011

(30) Foreign Application Priority Data
Sep. 9, 2011 (CN) 201110267156.2

(51) Int. Cl. H01R 12/73

(52) U.S. Cl. 439/206

(57) ABSTRACT

An electrical connector mounting on a printed circuit board includes an insulative housing and a number of power contacts received in the housing. The housing includes a main portion and a mating portion extending forwardly from the main portion. The mating portion has side walls and a receiving space surrounded by the side walls. The main portion has a mounting face and the mating portion has a mating face from which an opening is defined. The insulative housing defines at least one heat dissipation slot recessed from the mating face which extends inwards and communicating to the receiving space of the mating portion.

### BACKGROUND OF THE INVENTION

1. Field of the Invention

The present invention relates to an electrical connector, and more particularly to a power connector mounting on a printed circuit board.

2. Description of Related Art

Mateable power receptacle and power plug are commonly used for power transmission. It is known that heat is generated by impedance of power contacts during power transmission. Nowadays, more and more electronic devices need heavy power to work, and power connector assemblies which can endure high current are accordingly needed. Heat dissipation becomes one of the most annoying problems in connector design. If the heat is limited in insulative housings of the power connector assembly, and cannot be eliminated timely, the insulative housings might be burnt. Besides, mateable contact portions of contacts of the power connector assembly might melt. The high temperature once monitored by the client-side will crash the electronic devices. Bad heat dissipation may result in security problems for the worse.

U.S. Pat. No. 6,994,598 B2 issued to Holmes et al. on Feb. 7, 2006 discloses a traditional power connector assembly. The power connector assembly includes a male connector and a female connector both provided with multiple power contacts retained in an insulative housing. However, such power contacts are closed in the insulative housings when the male connector and the female connector are mated with each other for power transmission. As a result, heat dissipation thereof is poor.

Hence, a power connector with improved heat dissipation path is needed to solve the above problem.

### BRIEF SUMMARY OF THE INVENTION

Accordingly, an object of the present invention is to provide a electrical connector which is of simple structure, easy to be assembled, and of high reliability.

In order to achieve the above-mentioned object, an electrical connector in accordance with the present invention, which is mounted on a printed circuit board, comprises an insulative housing and a plurality of power contacts received in the housing. The housing includes a main portion and a mating portion extending forwardly from the main portion. The mating portion has side walls and a receiving space surrounded by the side walls. The main portion has a mounting face and the mating portion has a mating face from which an opening is defined. The insulative housing defines at least one heat dissipation slot recessed from the mating face which extends inwards and communicating to the receiving space of the mating portion.

The foregoing has outlined rather broadly the features and technical advantages of the present invention in order that the detailed description of the invention that follows may be better understood. Additional features and advantages of the invention will be described hereinafter, which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is an assembled, perspective view of an electrical connector in accordance with the present invention;

FIG. 2 is view similar to FIG. 1 while taken from another aspect;

FIG. 3 is a partially assembled, perspective view of the present invention;

FIG. 4 is a view similar to FIG. 3 while taken from another aspect;

FIG. 5 is a front view of the present invention;

FIG. 6 is cross-section view of the present invention along VI-VI line of FIG. 5 showing power contacts; and

FIG. 7 is a cross-section view of the present invention along VII-VII line of FIG. 5 showing signal contacts.

### DETAILED DESCRIPTION OF THE PREFERRED EMBODIMENTS

In the following description, numerous specific details are set forth to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted inasmuch as such details are not necessary to obtain a complete understanding of the present invention and are within the skills of persons of ordinary skill in the relevant art.

Reference will be made to the drawing figures to describe the present invention in detail, wherein depicted elements are not necessarily shown to scale and wherein like or similar elements are designated by same or similar reference numeral through the several views and same or similar terminology.

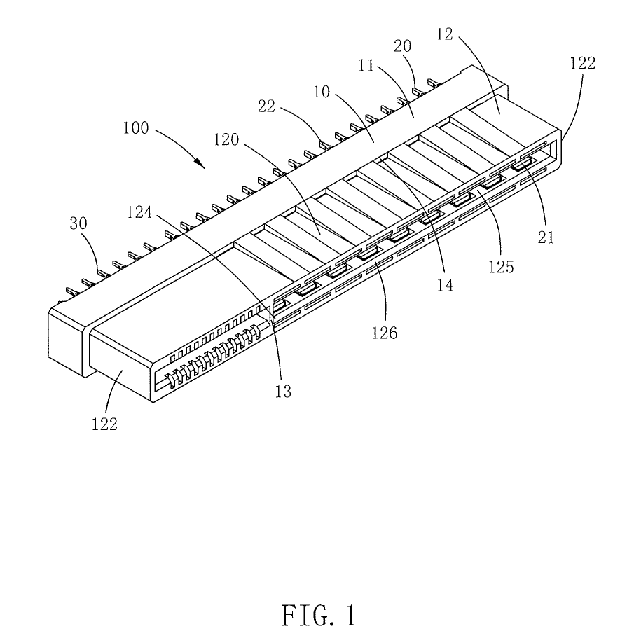

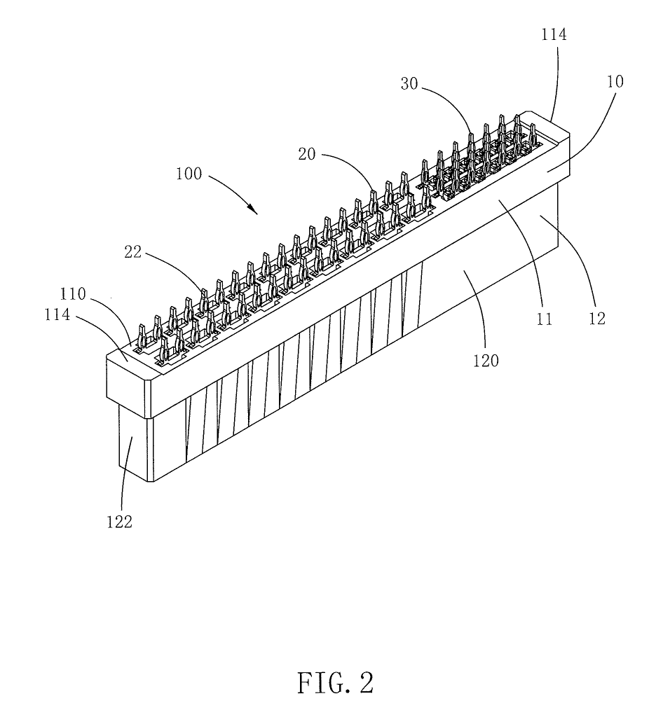

Please refer to FIGS. 1-2, an electrical connector 100 in accordance with the present invention comprises an insulative housing 10, a plurality of power contacts 20 retained in the insulative housing 10, and a plurality of signal contacts 30 received in the insulative housing 10. In the preferred embodiment of the present invention, the electrical connector 100 comprises nine pairs of power contacts 20 and twelve pairs of signal contacts 30. The signal contacts 30 are located at a lateral side of the power contacts 20. However, the number and corresponding position arrangement of the power contacts 20 and the signal contacts 30 could be variable in alternative embodiments.

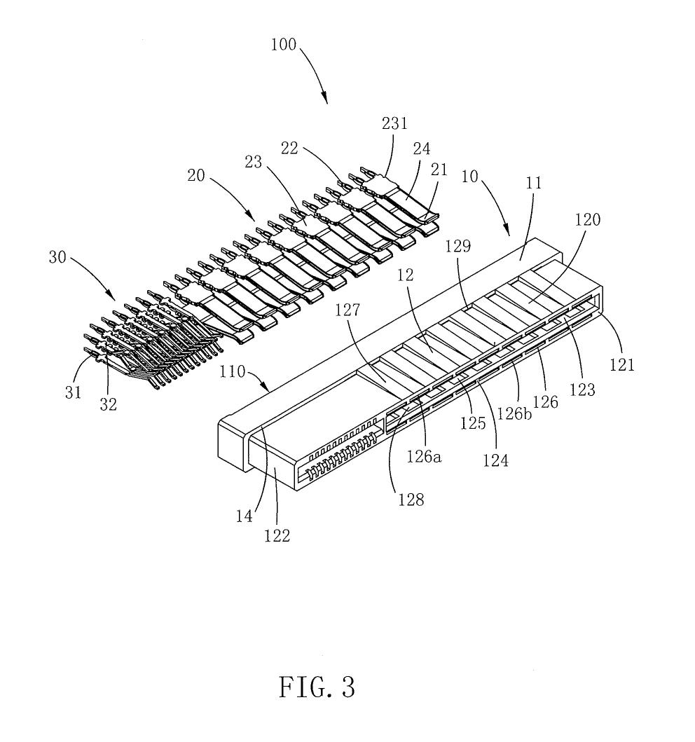

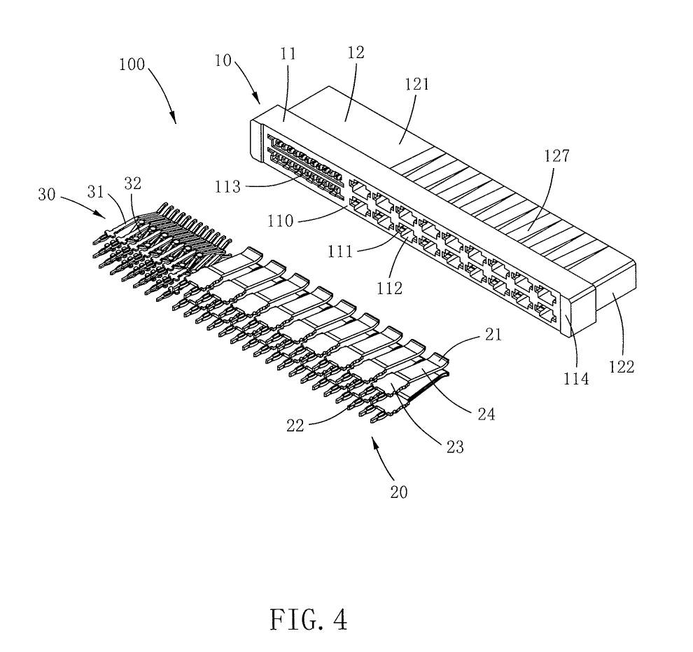

Referring to FIGS. 3-4 together with FIGS. 1-2, the insulative housing 10 comprises a main portion 11 and a mating portion 12 extending forwardly from the main portion 11. The main portion 11 provides a mounting face 110, a plurality of first mounting channels 111 for insertion of the power contacts 20 from the mounting face 110, a plurality of first through holes 112 communicating with the first mounting channels 111, and a plurality of second mounting channels 113 for insertion of the signal contacts 30. Both the power contacts 20 and the signal contacts 30 are assembled to corresponding first mounting channel 111 and second mounting channel 113 from the mounting face along a back-to-front direction. The main portion 11 of the insulative housing 10 forms a pair of protrusions 114 which projects beyond the mounting face 110. When the electrical connector 100 is assembled to an external device (not shown), e.g. a printed circuit board (PCB), a room defined between the mounting face 110 and the external device is employed to deliver heat airflow dissipated from the first through hole 112.

Turn to FIG. 3, the mating portion 12 includes a top wall 120, a bottom wall 121 opposite to the top wall 120, and a pair of end walls 122 connecting the top wall 120 and the bottom wall 121. The mating portion 12 also defines a mating face 124 in the front thereof. A receiving space 123 is defined by the top wall 120, the bottom wall 121 together with the pair of end walls 122 for receiving a complementary connector (not shown).

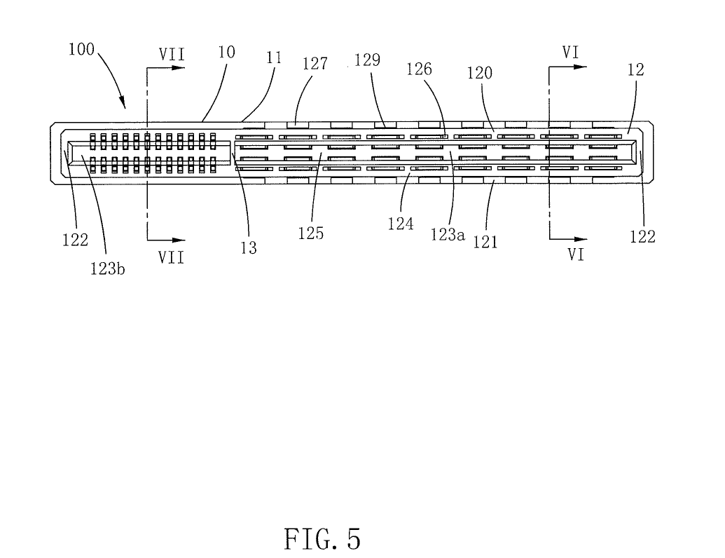

Referring to FIG. 5, the mating face 124 has a mating opening 125 which communicates with the receiving space 123. The mating opening 125 is elongated. The insulative housing 10 forms a dividing wall 13 dividing the receiving space 123 into a first receiving space 123a for receiving the power contacts 20 and a second receiving space 123b for receiving the signal contacts 30.

Together referring to FIGS. 3-5, a plurality of passageways 128 for receiving the power contacts 20 are respectively defined on the top wall 120 and the bottom wall 121 of the mating portion 11 of the insulative housing 10. The plurality of passageways 128 are opened towards and communicating with the receiving space 123. The insulative housing 10 defines a plurality of heat dissipation slots 126 recessed from the mating face 124 and communicating with the receiving space 123. The heat dissipation slots 126 are separated formed from the mating opening 125 at the mating face 124. That is, the heat dissipation slots are not in communication with the mating opening 125 directly. The plurality of heat dissipation slots 126 provide upper heat dissipation slots 126a extending through the top wall 120 and lower heat dissipation slots 126b extending through the bottom wall 121. Both the upper heat dissipation slots 126a and the lower heat dissipation slots 126b are arranged along a lengthwise direction of the mating portion 12 of the insulative housing 10. In this preferred embodiment, the width of the heat dissipation slot 126 is larger than the width of the passageway 128. Understandably, in other application, the plurality of heat dissipation slots 126 could be communicating with each other and forms one slot.

The insulative housing 10 forms a plurality of reinforcing ribs 127 on outside surface of the top wall 120. Similarly, a plurality of reinforcing ribs 127 are also formed on outside surface of the bottom wall 121. The ribs 127 are used to reinforce the rigidity of the mating portion 12 of the insulative housing 10 to thereby prevent the mating portion 12 from undesired deforming. The ribs 127 extend from the main portion 10 to the mating face 124 along an extending direction of the mating portion 12. The thickness or the height of the ribs 127 are linearly changed. In the present embodiment, the ribs 127 are shaped at wedge. As can be understood, in other application or embodiment, the ribs 127 can be any shape and extend along different directions. In the preferred embodiment, the rib 127 is positioned between the two neighbored heat dissipation slots 126. The width of the rib 127 is smaller than that of the heat dissipation slot 126. The heat dissipation slots 126, the passageway 128, the receiving space 123 and the first through hole 112 together with the room formed between the mounting face 110 and the external device, defines airflow channel, so as to dissipate the heat generated from the power contacts 20 when in use.

Turn back to FIG. 3, the insulative housing 10 defines a plurality of heat dissipation slits 129 at the portion where the main portion 11 and the mating portion 12 are interconnected. A stepped face 14 is formed between the main portion 11 and the top wall 120 and the bottom wall 121 of the mating portion 12 because of the different dimension of the cross sections thereof. The slits 129 extend through the stepped face 14 and communicate with the first through holes 112. The airflow can be circulate between the heat dissipation slits 129, the first through holes 112 and the room formed between the mounting face 110 and the external device. In this preferred embodiment, the slit 129 is arranged between the two neighbored ribs 127.

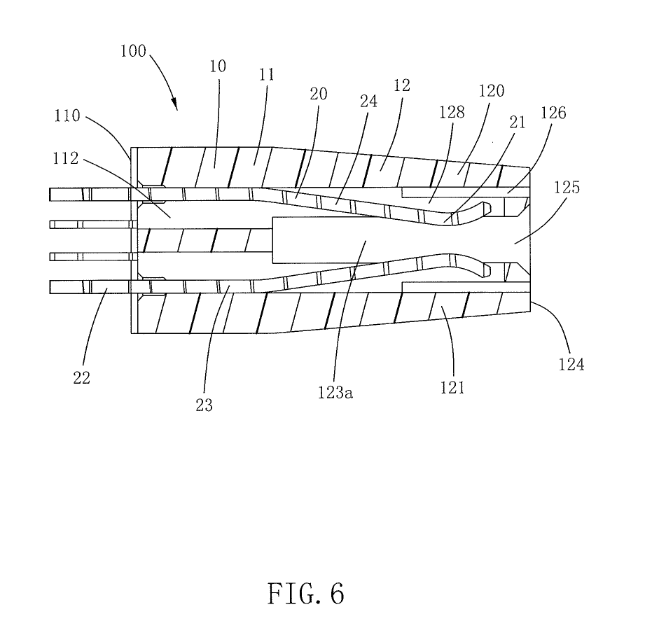

Referring to FIGS. 3-4 together with FIG. 6, each of the power contacts 20 comprises a contact portion 21, a mounting portion 22 for mounting onto the external device, a retaining portion 23 between the contact portion 21 and the mounting portion 22 for retaining the contact 20 on the insulative housing 10, and a connecting portion 24 interconnecting the retaining portion 23 and the contact portion 21. The contact portion 21 of the power contact 20 extends within the first receiving space 123a for mating with complementary connector. The mounting portion 22 extends beyond the mounting face 110 of the main portion 11. The retaining portion 23 forms barbs 231 thereon for engaging with the first mounting channel 111 of the main portion 11 to thereby secure the power contact 20 therein. The plurality of power contacts 20 are arranged into two rows and respectively received in the passageways 128 of the top walls 120 and the bottom wall 121. The two rows of the contact portions 21 are confront each other.

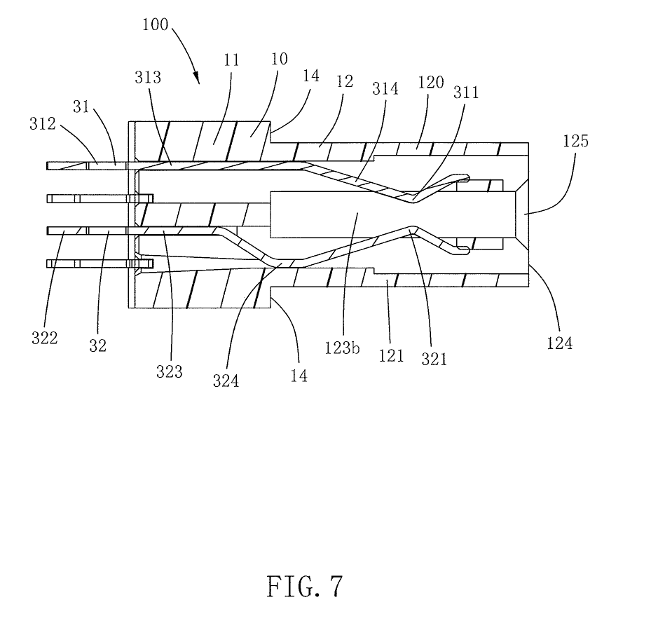

Together referring to FIGS. 3-4 and FIG. 7, the signal contacts 30 includes a first signal contact 31 and a second signal contact 32 which has different structure with the first signal contact 31. The first signal contact 31 comprises a first contact portion 311 received in the second receiving space 123b, a first mounting portion 312 extending beyond the mounting face 110 for mounting to the external device, a first retaining portion 313 for retaining the first signal contact 31 to the housing 10, and the first connecting portion 314 interconnecting between the first contact portion 311 and the first retaining portion 313. Similarly, the second signal contact 32 comprises a second contact portion 321 received in the second receiving space 123b, a second mounting portion 322 extending beyond the mounting face 110 for mounting to the external device, a second retaining portion 323 for retaining the second signal contact 32 to the housing 10, and the second connecting portion 324 interconnecting between the second contact portion 321 and the second retaining portion 323. The difference between the first and the second signal contacts is that the extending directions of the first connecting portion 314 and the second connecting portion 324 are different. The signal contacts 30 are arranged into two rows which is respectively at the top wall 120 and the bottom wall 121. The first signal contact 31 and the second signal contact 32 are alternatively arranged in each row of the contacts 30. Moreover, the first signal contact 31 in one row of the contacts 30 is confront to a second signal contact 32 in other row of the contacts 30.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed. For example, the tongue portion is extended in its length or is arranged on a reverse side thereof opposite to the supporting side with other contacts but still holding the contacts with an arrangement indicated by the broad general meaning of the terms in which the appended claims are expressed.

We claim:

1. An electrical connector mounting on a printed circuit board (PCB), comprising:
an insulative housing comprising a main portion and a mating portion extending forwardly from the main portion, said mating portion having a plurality of side walls and a receiving space surrounded by said side walls, said main portion having a mounting face, said mating portion having a mating face from which an opening is defined, said opening communicating with said receiving space, said insulative housing defines at least one heat dissipation slot recessed from said mating face, said at least one heat dissipation slot extending inwards and communicating to said receiving space of the mating portion; and
a plurality of power contacts received in the insulative housing, each power contact comprising a contacting portion extending within said receiving space, a mounting portion projecting beyond the mounting face and a retaining portion connecting the contacting portion and the mounting portion, respectively.

2. The electrical connector as claimed in claim 1, wherein said at least one slot is separated from said opening of said mating portion.

3. The electrical connector as claimed in claim 2, wherein said plurality of side walls of said mating portion includes a top wall, a bottom wall opposite to said top wall, a pair of end walls connecting said top wall and said bottom wall.

4. The electrical connector as claimed in claim 3, wherein said insulative housing defines a plurality of passageways on said top wall and said bottom wall, respectively, and wherein said plurality of passageways communicate with said receiving space and receive corresponding power contacts.

5. The electrical connector as claimed in claim 4, wherein said at least one heat dissipation slot includes an upper slot extending through said top wall from said mating face and a lower slot extending through said bottom wall from said mating face.

6. The electrical connector as claimed in claim 3, wherein said top wall and said bottom wall each provides a plurality of reinforcing ribs thereon.

7. The electrical connector as claimed in claim 3, wherein said insulative housing defines at least one heat dissipation slit at where the mating portion connects with the main portion, and wherein said top wall and said bottom wall each provides a plurality of reinforcing ribs thereon, said at least one heat dissipation slit being located between adjacent two reinforcing ribs.

8. The electrical connector as claimed in claim 1, wherein said insulating housing defines a protrusion projecting beyond the mounting face of the main portion.

9. The electrical connector assembly as claimed in claim 1, wherein said plurality of power contacts are arranged into pairs.

10. The electrical connector as claimed in claim 9, wherein said insulative housing defines a stepped face at where said main portion and said mating portion are connected, and wherein the insulative housing defines a plurality of heat dissipation slits through said steeped face.

11. The electrical connector as claimed in claim 1, wherein said insulating housing defines a dividing wall dividing said receiving space into two spaces including a first receiving space and a second receiving space.

12. The electrical connector as claimed in claim 9, further including a plurality of signal contacts received in one of said first and said second receiving spaces.

13. The electrical connector as claimed in claim 12, wherein the signal contacts includes a first signal contact and a second signal contact which has different structure with the first signal contact.

14. The electrical connector as claimed in claim 13, wherein each of the first signal contact comprises a first contact portion received in the receiving space, a first mounting portion extending beyond the mounting face, a first retaining portion for retaining the first signal contact to the housing 10, and the first connecting portion interconnecting the first contact portion and the first retaining portion.

15. The electrical connector as claimed in claim 13, wherein the second signal contact comprises a second contact portion received in the receiving space, a second mounting portion extending beyond the mounting face, a second retaining portion for retaining the second signal contact to the housing, and the second connecting portion interconnecting the second contact portion and the second retaining portion.

16. The electrical connector as claimed in claim 15, wherein the extending directions of the first connecting portion of the first signal contact and the second connecting portion of the second signal contact are different.

17. The electrical connector as claimed in claim 13, wherein the signal contacts are arranged into two rows which is respectively located at the top wall and the bottom wall, and wherein the first signal contact and the second signal contact are alternatively arranged in each row of the contacts, and wherein the first signal contact in one row of the signal contacts is confront to a second signal contact in other row.

18. An electrical connector comprising:
an insulative housing comprising a main portion and a mating portion extending forwardly from the main portion, said mating portion having a receiving space, said main portion having a plurality of first mounting channels communicating with said receiving space, said mating portion defining at least one first heat dissipation slot away from said main portion and at least one second heat dissipation slot near said main portion, said at least one first heat dissipation slot communicating to said receiving space of the mating portion and said at least one second heat dissipation slot communicating to said first mounting channels of said main portion; and
a plurality of power contacts received in said first mounting channels of said main portion of said insulative housing, each said power contact comprising a contacting portion extending within said receiving space and a retaining portion positioned in said first mounting channels; wherein
heat generated by said contacting portion in said receiving space can flow through said at least one first heat dissipation slot to outside and heat generated by said retaining portion in said first mounting channels can flow through said at least one second heat dissipation slot to outside.

19. The electrical connector as claimed in claim 18, wherein said mating portion provides a plurality of reinforcing ribs on a top face and a bottom face.

20. The electrical connector as claimed in claim 19, wherein the at least one second heat dissipation slot are between the reinforcing ribs.
